(19) United States
(12) Patent Application Publication
(10) Pub. No.: US 2019/0075407 A1
(43) Pub. Date: Mar. 7, 2019

(54) HEARING DEVICE

(71) Applicant: SIVANTOS PTE. LTD., SINGAPORE (SG)

(72) Inventors: ERWIN SINGER, ECKENTAL (DE); CHRISTIAN SCHMITT, GROSSENSEEBACH (DE); BENJAMIN SCHMIDT, ROETHENBACH AN DER PEGNITZ (DE)

(21) Appl. No.: 16/047,258

(22) Filed: Jul. 27, 2018

(30) Foreign Application Priority Data
Sep. 1, 2017 (DE) 102017215372.5

(51) Int. Cl. H04R 25/00

(52) U.S. Cl. CPC H04R 25/554; H04R 2225/025; H04R 2225/51; H04R 25/652

(57) ABSTRACT

A hearing device that can be produced particularly efficiently contains an antenna arrangement for wireless data transmission, in particular by magnetic induction. The antenna arrangement contains an antenna core made from a polymer matrix material into which a soft magnetic filler is embedded. A soft magnetic filler designates a filler made from a ferromagnetic material, i.e. from a material that can be easily magnetized in a magnetic field but does not itself form a magnetic field.

### CROSS-REFERENCE TO RELATED APPLICATION

This application claims the priority, under 35 U.S.C. § 119, of German application DE 10 2017 215 372.5, filed Sep. 1, 2017; the prior application is herewith incorporated by reference in its entirety.

### BACKGROUND OF THE INVENTION

### Field of the Invention

The invention relates to a hearing device with an antenna arrangement for wireless data transmission by use of magnetic induction. The invention relates in particular to a hearing device with a housing which is insertable into an ear of a person (hereinafter also “user”) wearing the hearing device.

A hearing device serves to supply a hearing-impaired person with acoustic signals from the surroundings, the acoustic signals being suitably processed, in particular amplified, in order to compensate the specific hearing impairment. To this end, a hearing device usually contains an input transducer, for example in the form of a microphone, a signal processing unit with an amplifier, and an output transducer. The output transducer is generally realized as a miniaturized loudspeaker and is also referred to as a receiver. It in particular generates acoustic output signals which are fed to the auditory system of the patient and provide the latter with the desired auditory perception.

Different designs of hearing devices are offered in order to meet the great many individual requirements. In the case of behind-the-ear (BTE) hearing devices, a housing that contains components such as a battery and the signal processing unit is worn behind the ear. Depending on the design, the receiver can be arranged directly in the auditory canal of the wearer, namely receiver-in-canal (RIC) hearing devices or, alternatively, the receiver is arranged inside the housing itself and a flexible sound tube guides the acoustic output signals of the receiver from the housing to the auditory canal. In the case of in-the-ear (ITE) hearing devices, a housing that contains all the functional components, including the microphone and the receiver, is worn at least partly in the auditory canal. Completely-in-canal (CIC) hearing devices are similar to the ITE hearing devices but are worn completely in the auditory canal.

An “instant-fit hearing device” is a design of an in-the-ear hearing device in which the housing has a standard shape that is not adapted individually, wherein a flexible retainer dome, with which the hearing device can be secured in the auditory canal, is fitted onto the housing.

Hearing devices often have an inductive antenna for wireless communication with another device, for example with an audio device, a remote control or (in the case of a binaural aid) a second hearing device. The antenna is configured, for example, as an antenna coil or ring antenna. Such a ring antenna is known in a conventional design from published, European patent application EP 2 811 761 A1, corresponding to U.S. Pat. No. 9,521,494 for example.

### SUMMARY OF THE INVENTION

The object of the invention is to make available a hearing device which has an antenna arrangement for inductive data transmission and which can be produced particularly efficiently.

This object is achieved, according to the invention, by the features of the main independent claim. Advantageous embodiments of the invention are set forth in the dependent claims and in the description below.

The hearing device according to the invention contains an antenna arrangement for wireless data transmission, in particular by magnetic induction. According to the invention, the antenna arrangement contains an antenna core produced from a polymer matrix material into which a soft magnetic filler is embedded. In a preferred embodiment, the filler is present in a particulate form (i.e. as a powder). A “soft magnetic filler” designates a filler made from a ferromagnetic material, i.e. from a material that can be easily magnetized in a magnetic field but does not itself form a magnetic field. Accordingly, in the context of the invention, a metal or a ceramic material (ferrite) is used in particular as filler. A powder of hard ferrite is preferably used as filler. The antenna core is preferably produced in an injection-molding method.

Through the use, according to the invention, of a composite material for producing the antenna core, the mechanical properties of the matrix material and the electromagnetic properties of the filler are advantageously combined. In particular, the used composite material is less brittle than the ferrite cores that are customarily used in most cases. By virtue of the comparatively mechanically softer material, there is less risk of the antenna core being damaged under mechanical loads, for example when it is being assembled or transported, or if the antenna core falls off. The assembling of the hearing device is simplified overall by the relatively non-sensitive antenna core.

Moreover, the composite material according to the invention advantageously acts as an acoustic seal, such that the antenna core can advantageously be used itself as an acoustic seal, as a result of which the assembly work for the hearing device is additionally reduced.

Through the use, according to the invention, of a plastics-based composite material as the antenna core, there is also advantageously a considerable freedom of design as regards the shape of the antenna core. For example, the design of the core can very easily be adapted to external conditions such as the shape of a hearing device housing in an individually adapted in-the-ear hearing device. Through the design freedom, the shape of the antenna core can also be advantageously adapted with respect to shielding from electromagnetic interference. This is particularly advantageous in the typically confined installation space of in-the-ear hearing devices.

In a preferred embodiment of the invention, a thermoplastic or an elastomer is used as matrix material, depending on the design of the antenna core. The matrix material is thus preferably formed by a rigid (comparatively inflexible) plastic or by an elastic plastic (by a rubber material). For example, the thermoplastic used is a polyamide, in particular PA 6 or PA 12. A fluoro rubber (in particular “Viton” from DuPont) is used as an elastomer for example.

In the context of the invention, it is also possible that the antenna core is produced in one section from a thermoplastic and in another section from an elastomer. In this case, the antenna core is produced in particular in the course of a two-component injection-molding process.

In a preferred embodiment of the invention, the antenna core is used as an acoustic seal. In this embodiment, an elastomer is expediently used as matrix material. In particular, a sound channel leading from a receiver of the hearing device to a sound outlet of the hearing device is routed through the interior of the antenna core. In this way, the work involved in manufacturing and assembling the hearing device is greatly reduced, since the antenna core itself functions as an acoustic seal, such that further measures, for example a separate rubber hose or a silicone adhesive, can advantageously be omitted.

In addition or alternatively, the antenna core is used as a mechanically supporting component, i.e. another component of the hearing device, for example a receiver of the hearing device, is mounted on the antenna core and held by the latter. For this purpose, a thermoplastic (hard in the processed state) is preferably used as matrix material. Through the supporting function of the antenna core, it is possible to realize particularly compact designs of the hearing device.

In particular, the core material according to the invention makes it possible, and provision is made in a development of the invention, that the antenna core has a mechanical connection element. According to this embodiment, a mechanical connection element is formed from the antenna core. The connection element is connected integrally to the antenna core. Preferably, the connection element is configured to form a screw connection or snap-fit connection.

Here, and in the following, the term “integrally connected” signifies a monolithic connection of two components. That is to say, the two components (in the present case the antenna core and the connection element) are produced from the same material and are in particular produced in a common manufacturing process (in one molding).

In one embodiment, the antenna core has substantially the shape of a hollow cylinder open at both ends, wherein the hollow cylinder widens at one longitudinal end to form a flange. A receiver of the hearing device is mountable or mounted on the flange, such that sound output from the receiver is guided in a sound channel in the interior of the antenna core. That is to say, the cavity formed by the hollow cylinder serves as a sound channel. By the core material according to the invention, and by its sound-damping effect, no further acoustic sealing is needed besides the antenna core itself. Moreover, by virtue of its configuration, the antenna core acts positively on the magnetic field formation and serves in particular as a magnetic shield in relation to the receiver. Electromagnetic interference caused by the receiver, which would adversely affect the inductive data transmission provided by the antenna arrangement, is thus advantageously suppressed.

The invention proves particularly advantageous in a hearing device configured as an instant-fit hearing device. In this embodiment, the hearing device contains a housing insertable into an auditory canal of a person wearing the hearing device, a flexible retainer dome which is secured releasably on the housing and retains the housing in the auditory canal, and a housing-side connection element onto which the retainer dome can be plugged with a corresponding dome-side connection element. Here, the housing-side connection element is connected integrally to the antenna core. The manufacturing outlay for such a hearing device is advantageously greatly reduced compared to a conventional design.

In a further advantageous embodiment, the hearing device contains a housing insertable into an auditory canal of a person wearing the hearing device. The housing contains a one-part housing shell which accommodates a structural unit comprising a receiver and the antenna arrangement, wherein the housing shell has a first, front-side opening, which is closed with a face plate, and a second, rear-side opening, which lies substantially opposite the first opening. The structural unit protrudes with a retainer stub from the rear-side opening, wherein the structural unit is fixed on the housing shell by a securing ring fitted externally on the retainer stub. The retainer stub is connected integrally to the antenna core. In this embodiment too, the hearing device is preferably designed as an instant-fit hearing device with a non-individually adapted housing shell and with a retainer dome that can be secured on the latter. In a preferred combination, retainer stub and housing-side connection element are connected integrally to the antenna core.

Other features which are considered as characteristic for the invention are set forth in the appended claims.

Although the invention is illustrated and described herein as embodied in a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a hearing device containing a one-piece housing shell which is closed by a face plate and in which a structural unit containing a receiver and an antenna arrangement is received, the structural unit being fixed by a securing ring which is fitted onto a retainer stub of the structural unit protruding from the housing shell according to the invention and

FIG. 2 is a perspective view of an antenna core of an antenna arrangement according to FIG. 1, wherein the antenna core is produced from an elastic material.

### DETAILED DESCRIPTION OF THE INVENTION

Parts corresponding to one another are always labeled with the same reference signs in all of the figures.

Referring now to the figures of the drawings in detail and first, particularly to FIG. 1 thereof, there is shown a hearing device 1 which contains a housing 2 for accommodating hearing device components. The view shows a partially schematic longitudinal section through the hearing device 1, such that a housing interior 3 enclosed by the housing 2 is visible, as also are the hearing device components accommodated wholly or partially therein, including a microphone 4, a signal processor 5, a receiver 6, and an antenna arrangement 7 with an annular induction coil. The antenna arrangement 7 serves, for example, for communication with a second hearing device of a person (“user”) wearing the hearing device 1 by magnetic induction or for communication with another peripheral device, for example a remote control.

The hearing device 1 is an in-the-ear hearing device to be worn in the auditory canal and designed as an instant-fit device. The housing 2 is accordingly produced as a standard part, i.e. is not custom made, wherein the hearing device 1 contains a flexible retainer dome 9 which is fitted releasably onto the housing 2. The retainer dome 9, produced from silicone for example, serves to fix the housing 2 in the auditory canal of the user.

With the hearing device 1 correctly inserted, a side of the housing 2 referred to as a rear side 12 is directed toward the eardrum of the user, while a side of the housing 2 referred to as the front side 13 is correctly directed toward the auricle.

The housing 2 contains a one-piece housing shell 15, and also a face plate 16 for closing the housing shell 15.

The housing shell 15 has in rough outline a hose-like shape which tapers toward the rear side 12. The housing shell 15 has a first, front-side (assembly) opening 20 and, lying approximately opposite the latter, a second, rear-side (assembly) opening 21. The front-side opening 20 serves for the insertion of the hearing device components into the housing shell 15.

The rear-side opening 21 serves for the assembly of the receiver 6 and of the antenna arrangement 7. For this purpose, the hearing device 1 contains a structural unit 25 which for its part contains a retainer stub 27 protruding from the opening 21, wherein the antenna arrangement 7 is received in the retainer stub 27, and wherein the receiver 6 is fixed on the antenna arrangement 7. A securing ring 30 fitted on the retainer stub 27 from the direction of the rear side 12 serves to fix the structural unit 25 on the housing shell 15.

Furthermore, the retainer stub 27 has a housing-side connection element 35 which is arranged outside the housing 2 and which corresponds to a dome-side connection element 36 of the retainer dome 9, such that the retainer dome 9 can be clicked onto the housing 2, specifically onto the connection element 35.

The retainer stub 27 is produced as a pot-like or beaker-shaped component made of plastic. The retainer stub 27 accordingly has a flat bottom 40, and a peripheral wall 41 which adjoins the bottom 40 and which encloses a hollow-cylindrical stub interior 42. The diameter of the retainer stub 27 corresponds approximately to the diameter of the opening 21. A peripheral, radially outwardly protruding limit stop 44 is integrally formed on an edge of the peripheral wall 41. In the assembled state, the retainer stub 27 sits in the opening 21, wherein the greater part of it protrudes from the housing shell 15 and, in the housing interior 3, bears with the limit stop 44 on an edge of the housing shell 15 surrounding the opening 21.

A circular (sound) opening 48 is introduced centrally into the bottom 40 of the retainer stub 27 and is enclosed by a collar 50 protruding vertically toward the stub interior 42. Toward the outside, the opening 48 is adjoined by the connection element 35. The connection element 35 is a short tube section made of metal which is oriented coaxially with the retainer stub 27, wherein the tube section is flush with the opening 48. At a first longitudinal end, the connection element 35 is formed into the bottom 40 of the retainer stub 27 with the aid of external circumferential ribs. At its second longitudinal end, the internal diameter of the connection element 35 widens in one step. In this region, the outer surface of the connection element 35 is bulged outward to form a ball-joint head 52. The connection element 35 is accordingly also referred to as a ball spout.

On an outer face of the peripheral wall 41, the retainer stub 27 has an outer thread 54 onto which the securing ring 30 is screwed, with a corresponding inner thread 56, from the outside of the housing 2 in order to fix the retainer stub 27 on the housing shell 15.

The antenna arrangement 7 is inserted into the stub interior 42 of the retainer stub 27, wherein both parts are oriented at least approximately coaxially.

The antenna arrangement 7 has a cylindrical induction coil (not shown explicitly here) and a likewise substantially hollow cylindrical antenna core 80 about which the induction coil is wound. The antenna core 80 of the antenna arrangement 7 is shown on its own in FIG. 2.

As can be seen from FIG. 2, the antenna core 80 has the shape of a hollow cylinder 81 open at both ends, wherein the antenna core 80 widens in one step at one longitudinal end in order to form a flange 82 (also “collar”). In plan view, the flange 82 has an approximately rectangular outer contour. In the correct installation position, the receiver 6 is mounted (as shown in FIG. 1) onto the end face of the antenna core 80 formed by the flange 82, such that sound generated by the receiver 6 is conveyed in a sound channel 84 routed through the interior of the antenna core 80. For example, the receiver 6 is adhesively bonded to the flange 82. Optionally, the flange 82 has connection elements which are formed out of the antenna core 80 and on which the receiver 6 is secured (for example clicked on or screwed on). In this case, the receiver 6 is individually exchangeable (i.e. without the antenna core 80).

The antenna core 80 is produced by injection molding from a composite material, wherein a particulate filler is homogeneously dispersed in a matrix material. In the illustrative embodiment, an elastomer is used as matrix material, in particular a fluoro rubber, for example from DuPont under the trade name “Viton”. A hard ferrite powder is used as filler.

By virtue of the rubber-like matrix material of the antenna core 80, the latter acts as an acoustic seal, such that the receiver 6 is mounted, without further measures for acoustic sealing, directly on the antenna core 80. In the illustrative embodiment, the rubber-like antenna core acts sealingly on the one hand at the connection site between receiver 6 and antenna core 80 and also on the other hand at the connection site between the antenna core 80 and the collar 50 of the retainer stub 27. A plastic or rubber hose, as is customarily provided between the receiver 6 and the antenna core 80, is omitted here. Moreover, the flange 82 acts as a shield, which magnetically shields the receiver 6 off from the antenna arrangement 7.

In the embodiment shown, the connection element 35 is produced from metal and is embedded into the retainer stub 27 in an injection molding process. Alternatively, connection element 35 and antenna core 80 are produced integrally (monolithically), for example as a jointly produced injection molding made of the material of the antenna core 80.

In a further embodiment, which is likewise not explicitly shown, the antenna core 80 and the retainer stub 27 are produced integrally (monolithically).

In a further alternative, the retainer stub 27 and the connection element 35 are produced integrally with the antenna core 80.

The invention will be particularly clear from the illustrative embodiments described above, but it is not limited to these illustrative embodiments. On the contrary, further embodiments of the invention can be derived from the claims and from the above description.

The following is a summary list of reference numerals and the corresponding structure used in the above description of the invention:
1 hearing device
2 housing
3 housing interior
4 microphone
5 signal processor
6 receiver
7 antenna arrangement
9 retainer dome
12 rear side
13 front side
15 housing shell
16 face plate
20 (assembly) opening
21 (assembly) opening
25 structural unit
27 retainer stub
30 securing ring
35 connection element
36 connection element
40 bottom
41 peripheral wall
42 stub interior
44 limit stop
48 (sound) opening
50 collar
52 ball-joint head
54 outer thread
56 inner thread
80 antenna core
82 flange
84 sound channel

1. A hearing device, comprising:
an antenna configuration for wireless data transmission, said antenna configuration having an antenna core made from a polymer matrix material into which a magnetic filler is embedded.

2. The hearing device according to claim 1, wherein said matrix material is selected from the group consisting of a thermoplastic and an elastomer.

3. The hearing device according to claim 1, wherein said magnetic filler contains a powder of hard ferrite.

4. The hearing device according to claim 1, wherein said antenna core is used as an acoustic seal.

5. The hearing device according to claim 1, wherein said antenna core is used as a mechanically supporting component.

6. The hearing device according to claim 1, wherein said antenna core has a mechanical connection element.

7. The hearing device according to claim 6, wherein said antenna core has a connection element for forming a screw connection or a snap-fit connection.

8. The hearing device according to claim 1,
wherein said antenna core has substantially a shape of a hollow cylinder being open at both ends, and widens at one of said ends to form a flange and defines a sound channel; and
further comprising a receiver mounted on said flange, such that sound output from said receiver is guided in said sound channel in an interior of said antenna core.

9. The hearing device according to claim 1, further comprising:
a housing insertable into an auditory canal of a person wearing the hearing device;
a flexible retainer dome secured releasably on said housing and retaining said housing in the auditory canal, said flexible retainer dome having a corresponding dome-side connection element; and
a housing-side connection element onto which said flexible retainer dome is plugged with said corresponding dome-side connection element, said housing-side connection element being connected integrally to said antenna core.

10. The hearing device according to claim 1,
further comprising a structural unit having a receiver and said antenna configuration;
further comprising a housing insertable into an auditory canal of a person wearing the hearing device, said housing having a one-part housing shell which accommodates said structural unit having said receiver and said antenna arrangement;
wherein said housing shell has a first, front-side opening formed therein, which is closed with a face plate, and a second, rear-side opening formed therein, which lies substantially opposite said first, front-side opening;
further comprising a retainer stub, wherein said structural unit protrudes with said retainer stub from said second, rear-side opening;
further comprising a securing ring, said structural unit is fixed on said housing shell by said securing ring fitted externally on said retainer stub; and
wherein said retainer stub is connected integrally to said antenna core.

11. The hearing device according to claim 1, wherein the wireless data transmission is performed by magnetic induction.
